(19) United States
(12) Patent Application Publication
(10) Pub. No.: US 2026/0329814 A1
(43) Pub. Date: Oct. 22, 2026

(54) SYSTEMS AND METHODS FOR DATABASE POSTING OF JOURNAL ENTRIES IN A MULTI-TENANT SYSTEM

(71) Applicant: Zuora, Inc., Redwood City, CA (US)

(72) Inventors: Manasa Ranjan Tripathy, Hyderabad (IN); Poornachander Venkata Byri, Union City, CA (US); PraveenKumar Rajendiran, Chennai (IN); Rajashekhar Polishetty, Hyderabad (IN); Rajesh Dayalan, Chennai (IN); Bisai Harshavardhan, Secunderabad (IN); Akshitha Tekulapally, Hyderabad (IN)

(73) Assignee: Zuora, Inc., Redwood City, CA (US)

(21) Appl. No.: 19/182,326

(22) Filed: Apr. 17, 2025

(51) Int. Cl. G06F 16/18

(52) U.S. Cl. CPC G06F 16/1815

(57) ABSTRACT

The multi-tenant system includes hardware processors that communicate with a journal entry database to obtain journal entries having corresponding temporal attributes, populating, into respective batch identifier fields of the journal entries, a default batch identifier, and determining individually whether each of the temporal attributes satisfy a temporal criteria. For any temporally conforming journal entries, which have the default batch identifier and have temporal attributes satisfying the temporal criteria, the hardware processors are configured to generate an assigned batch identifier, replace the default batch identifier with the assigned batch identifier, and batch the any temporally conforming journal entries into the batch while excluding from the batch any temporally nonconforming journal entries. During a posting phase, the hardware processors are configured to generate a summarized entry based on the any temporally conforming journal entries within the batch and insert the summarized entry into a posting database.

### TECHNICAL FIELD

This disclosure pertains to multi-tenant subscription data, and more particularly pertains to systems and methods for posting large amounts of records in different databases in a multi-tenant system.

### BACKGROUND

Some multi-tenant systems store records of subscription-based data, such as resource consumption of subscribers under various subscriptions. These records may be in the form of journal entries. Processing of journal entries may include posting them. Considering the huge volume of journal entries, which may include billions posted within the span of hours, systems and methods to efficiently track posting journal entries are needed.

### SUMMARY

A claimed solution rooted in computer technology overcomes problems specifically arising in the realm of computer technology. Embodiments of the present invention implement a journal entry posting system, and more generally, a database posting system, within a multi-tenant system. The journal entry posting system is configured to batch, from a journal entry database, journal entries. Batching the journal entries may include obtaining the journal entries. The journal entries may include transaction details as well as attributes of the journal entries, such as posting statuses, time periods to which the journal entries belong, creation times, and assigned batch identifiers. In some embodiments, the journal entry posting system may obtain on an order of billions of journal entries and post the journal entries within hours. The journal entries may have a structured format, e.g., a tabular, columnar, or hybrid format. Within the journal entries database, the journal entries may be partitioned in separate storage partitions. The partitioning of the journal entries may be based on criteria including a tenant, temporal attributes, or a schema of the journal entries. Partitioning the journal entries may include assigning the journal entries to separate storage partitions according to the aforementioned criteria.

In some embodiments, batching the journal entries may include generating batch identifiers and assigning one of the batch identifiers to each of the journal entries. The batch identifier may be assigned based on temporal attributes of the journal entries such as time periods to which they belong. For example, every journal entry belonging to a given month, day, or other time window may be assigned a same batch identifier. Each different batch may be assigned a unique batch identifier. In some embodiments, each batch identifier may be predetermined during creation of journal entries in order to avoid updating of the batch identifier during posting.

The journal entry posting system is configured to post each batch of the journal entries in a posting database. In some embodiments, posting may include transferring journal entries from a journal into a different ledger, such as a general ledger in the posting database. In some embodiments, posting the journal entries may encompass transforming the batched journal entries or generating a posting table using at least a subset of journal entry attribute values, and inserting the transformed journal entries or the posting table into the posting database. The journal entry posting system may separately generate a posting table for each batch of journal entries. In some embodiments, generating a posting table may include summarizing each batch of journal entries. A result of the summarization may be populated into the posting table which is posted into a posting database.

In some embodiments, journal entry posting system is configured to stage the journal entries. Staging may include separating each batch into subbatches, generating one or more staging tables for the subbatches, and inserting the one or more staging tables into the posting database or to a staging database. Each staging table may include a summarization of each corresponding subbatch. In some embodiments, a single staging table may be generated for all subbatches. In some embodiments, the posting table may be generated by summarizing the staging tables within a given batch.

The journal entry posting system needs to track whether the journal entries have been posted in order to avoid redundant postings of a same journal entry or missed postings of journal entries. The journal entry posting system tracks posting status by assigning each journal entry to a batch, assigning unique batch identifiers to different batches, and maintaining a record (e.g., a historical record) of assigned batch identifiers. The journal entry posting system recognizes whether a particular journal entry has been posted by comparing a particular batch identifier belonging to the particular journal entry with a most recent batch identifier. In some embodiments, the most recent batch identifier may be for a currently open period. If the particular batch identifier does not match the most recent batch identifier, the journal entry posting system recognizes that the particular journal entry has already been posted as part of a previous batch or otherwise belongs to a previous batch. In that situation, the journal entry posting system leaves the particular journal entry unposted. If the particular batch identifier matches the most recent batch identifier, the journal entry posting system recognizes that the particular journal entry has not been posted. In that situation, the journal entry posting system posts the particular journal entry.

In this manner, the journal entry posting system tracks a posting status of the journal entries without writing or updating a flag of the posting statuses (e.g., a posting flag) in the journal entries every time that a journal entry is posted. Because such write operations would consume large amounts of computing resources compared to insertions, avoiding the writing of flags greatly reduces consumption of computing resources and time. These reductions are magnified when the number of journal entries is on the order of billions.

In addition to efficiently tracking posting status, the journal entry posting system confers other computing improvements. The journal entry posting system posts the journal entries into the posting database which may summarize a large corpus of journal entries. Summarizing provides a succinct view of relevant data within the journal entries while greatly reducing the amount of computing resources that would otherwise be consumed in searching and retrieval of the journal entries. Summarizing also reduces the computing steps to perform downstream processes such as generating analytics or reports. Additionally, posting of the journal entries may include parallel processing of different subbatches of the journal entries. Parallel processing efficiently allocates available computing resources to transform the journal entries while preventing overburdening, overheating or other malfunctioning of the computing resources. Moreover, the journal entries database implements an improved storage architecture. In this storage architecture, consumption records are partitioned into different storage partitions, which ensures security and efficient storage utilization among the different storage partitions. The journal entries themselves also have an improved storage format which improves efficiency of retrieval of the journal entries.

In some embodiments, the present invention provides a multi-tenant system, comprising: one or more hardware processors; and memory storing computer instructions, the computer instructions when executed by the one or more hardware processors configured to perform operations. The operations include, or are associated with, one or more batching phases and one or more posting phases. During a batching phase, the operations include obtaining, from a journal entry database, journal entries having corresponding temporal attributes; populating, into respective batch identifier fields of the journal entries, a default batch identifier; determining individually whether each of the temporal attributes satisfy a temporal criteria; and for any temporally conforming journal entries, which have the default batch identifier and have temporal attributes satisfying the temporal criteria: generating an assigned batch identifier; replacing the default batch identifier with the assigned batch identifier; and assigning the any temporally conforming journal entries into the batch while excluding from the batch any temporally nonconforming journal entries, which have the default batch identifier and have temporal attributes failing to satisfy the temporal criteria. During the first posting phase, the computer instructions when executed by the one or more hardware processors are configured to perform, generating a summarized entry based on the any temporally conforming journal entries within the batch; and inserting the summarized entry into a posting database.

In some embodiments, the journal entries belong to a same tenant.

In some embodiments, the temporal attributes comprise or identify respective time periods that the journal entries belong to, and the temporal criteria is satisfied based on any journal entries belonging to a particular time period.

In some embodiments, generating the summarized entry comprises aggregating across particular metered attribute value fields corresponding to the journal entries, wherein the particular metered attribute value fields are associated with a given metered attribute.

In some embodiments, the computer instructions when executed by the one or more hardware processors are further configured to perform: during the batching phase, dividing the batch into a first subbatch and a second subbatch; assigning a first subset of the temporally conforming journal entries to the first subbatch; assigning a second subset of the temporally conforming journal entries to the second subbatch; generating, within one or more staging databases, a first staging entry based on a summary of the first subset; and generating, within the one or more staging databases, a second staging entry based on a summary of the second subset; and during the posting phase, generating the summarized entry comprises summarizing the first staging entry and the second staging entry. In some embodiments, during the posting phase, generating the summarized entry comprises summarizing the first staging entry and the second staging entry.

In some embodiments, the computer instructions when executed by the one or more hardware processors are further configured to perform: during the batching phase, generating one or more batch status tables that are updated to track a posting status of the batch; and generating one or more subbatch status tables that are updated to track a posting status of the first subbatch and the second subbatch.

In some embodiments, the first staging entry comprises a first staging table, the second staging entry comprises a second staging table, and the summarized entry comprises a posting table.

In some embodiments, the batching phase comprises a first batching phase, and the posting phase comprises a first posting phase. In some embodiments, the temporal criteria comprises a first temporal criteria. In some embodiments, the journal entries comprise first journal entries, and the temporally conforming journal entries comprise temporally conforming first journal entries. In some embodiments, the batch identifier fields comprise first batch identifier fields, the assigned batch identifier comprises a first assigned batch identifier, and the batch comprises a first batch. In some embodiments, the first batch includes any journal entries that satisfy the first temporal criteria (e.g., created during or corresponding to a first particular time period, such as a first month). In some embodiments, the summarized entry comprises a first summarized entry. and the computer instructions when executed by the one or more hardware processors are configured to perform further operations. The operations include, during a second batching phase, obtaining, from the journal entry database, second journal entries having corresponding second temporal attributes. The operations include, populating, into respective second batch identifier fields of the second journal entries, the default batch identifier and determining individually whether each of the second temporal attributes satisfy a second temporal criteria. For any temporally conforming second journal entries, which have the default batch identifier and have second temporal attributes satisfying the second temporal criteria: the operations include generating an assigned second batch identifier that assigns a second batch identifier to the any temporally conforming second journal entries; replacing the default batch identifier (e.g., an unassigned batch identifier) with the assigned second batch identifier; and batching the any temporally conforming second journal entries into the second batch. In some embodiments, the second batch includes any journal entries that satisfy the second temporal criteria (e.g., created during or corresponding to a second particular time period, which may be subsequent to and nonoverlapping with the first particular time period, such as a second month). The operations include, determining, based on the temporally conforming first journal entries being assigned the first batch identifier distinct from the second batch identifier, that the temporally conforming first journal entries have already been posted. The operations include, during a second posting phase, generating a second summarized entry based on the any temporally conforming second journal entries within the batch; and inserting the second summarized entry into a posting database.

In some embodiments, the first posting phase may be performed at least partially in parallel or concurrently with the second batching phase.

In some embodiments, the computer instructions when executed by the one or more hardware processors are further configured to perform: during the first posting phase, validating the any temporally conforming first journal entries; in response to any one or more temporally conforming first journal entries within the batch being invalidated, modifying the batch identifier fields of the one or more invalidated journal entries to the default batch identifier; and generating an invalidated journal entries dataset based on the one or more invalidated journal entries.

In some embodiments, the computer instructions when executed by the one or more hardware processors are further configured to perform: during the second batching phase, for any temporally nonconforming second journal entries, which have the default batch identifier and have second temporal attributes failing to satisfy the second temporal criteria, flagging the temporally nonconforming second journal entries; and wherein the generating of the invalidated journal entries dataset is based on the flagged journal entries.

In some embodiments, the journal entries comprise corresponding posting flags identifying a posting status; and following the posting phase, the posting flags remain unchanged.

In some embodiments, the present invention may provide a method implemented by a multi-tenant system, the method comprising one or more batching phases and one or more posting phases. During a batching phase, the method includes obtaining, from a journal entry database, journal entries having corresponding temporal attributes; populating, into respective batch identifier fields of the journal entries, a default batch identifier; determining individually whether each of the temporal attributes satisfy a temporal criteria; and for any temporally conforming journal entries, which have the default batch identifier and have temporal attributes satisfying the temporal criteria: generating an assigned batch identifier; replacing the default batch identifier with the assigned batch identifier; and assigning the any temporally conforming journal entries into the batch while excluding from the batch any temporally nonconforming journal entries, which have the default batch identifier and have temporal attributes failing to satisfy the temporal criteria. During the first posting phase, the method comprises, generating a summarized entry based on the any temporally conforming journal entries within the batch; and inserting the summarized entry into a posting database.

These and other features of the systems, methods, and non-transitory computer readable media disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for purposes of illustration and description only and are not intended as a definition of the limits of the invention.

### BRIEF DESCRIPTION OF THE DRAWINGS

FIG. 1 is a block diagram of a network system for providing cloud-based software-as-a-service (SAAS) services of a multi-tenant system to multiple tenants, in accordance with some embodiments of the present invention.

FIG. 2A is a block diagram illustrating details of a journal entry posting system, in accordance with some embodiments of the present invention.

FIG. 2B is a diagram illustrating an example of a journal entry database to store journal entries prior to posting, in accordance with some embodiments of the present invention.

FIG. 3 is a diagram illustrating examples of journal entries, in accordance with some embodiments of the present invention.

FIG. 4 is a diagram illustrating batched journal entries, in accordance with some embodiments of the present invention.

FIG. 5 is a diagram illustrating subbatched journal entries, in accordance with some embodiments of the present invention.

FIG. 6 is a diagram illustrating an example of part of a staging phase and posting phase, in accordance with some embodiments of the present invention.

FIG. 7A is a diagram illustrating invalidated journal entries and generating of an invalidated journal entries dataset, in accordance with some embodiments of the present invention.

FIG. 7B is a diagram illustrating an example batch status table and an example subbatch status table, to track posting statuses of batches and subbatches, in accordance with some embodiments of the present invention.

FIG. 8 is a flowchart of a method of posting journal entries into a journal entry posting database, in accordance with some embodiments of the present invention.

FIG. 9 is a block diagram illustrating details of a computing system.

### DETAILED DESCRIPTION

A claimed solution rooted in computer technology overcomes problems specifically arising in the realm of computer technology. Embodiments of the present invention implement a journal entry posting system, and more generally a database posting system within a multi-tenant system. The journal entry posting system is configured to batch journal entries from a journal entry database. The journal entries may include transaction details as well as attributes, such as posting statuses, time periods to which the journal entries belong, creation times, and assigned batch identifiers. In some embodiments, within hours, the journal entry posting system may obtain billions of journal entries. The journal entries may have a structured format, e.g., a tabular, columnar, or hybrid format. Within the journal entries database, the journal entries may be partitioned in separate storage partitions. The partitioning of journal entries may be based on criteria including a tenant, temporal attributes, or a schema. Partitioning journal entries may include assigning the journal entries to separate storage partitions according to the aforementioned criteria.

In some embodiments, batching journal entries may include generating batch identifiers and assigning one of the batch identifiers to each of the journal entries. The batch identifier may be assigned based on temporal attributes such as time periods to which they belong. For example, every journal entry belonging to a given month, day, or other time window may be assigned a same batch identifier. Each different batch may be assigned a unique batch identifier.

The journal entry posting system is configured to post each batch of the journal entries in a posting database. In some embodiments, posting the journal entries may encompass transforming the batched journal entries or generating a posting table using at least a subset of journal entry attribute values, and inserting the transformed journal entries or posting table into the posting database. The journal entry posting system may separately generate a posting table for each batch of journal entries. In some embodiments, generating a posting table may include summarizing each batch of journal entries. A result of the summarization may be populated into the posting table, which is posted into a posting database.

In some embodiments, journal entry posting system is configured to stage the journal entries. Staging may include separating each batch into subbatches, individually generating a staging table for each subbatch, and inserting each staging table into a staging database. Each staging table may include a summarization of each corresponding subbatch. In some embodiments, the posting table may be generated by summarizing the staging tables within a given batch.

The journal entry posting system needs to track whether the journal entries have been posted in order to avoid redundant postings of a same journal entry or missed postings of journal entries. The journal entry posting system tracks posting status by assigning each journal entry to a batch, assigning unique batch identifiers to different batches, and maintaining a record (e.g., a historical record) of assigned batch identifiers. The journal entry posting system recognizes whether a particular journal entry has been posted by comparing a particular batch identifier belonging to the particular journal entry with a most recent batch identifier. If the particular batch identifier does not match the most recent batch identifier, the journal entry posting system recognizes that the particular journal entry has already been posted as part of a previous batch or otherwise belongs to a previous batch. In that situation, the journal entry posting system leaves the particular journal entry unposted. If the particular batch identifier matches the most recent batch identifier, the journal entry posting system recognizes that the particular journal entry has not been posted. In that situation, the journal entry posting system posts the particular journal entry.

In this manner, the journal entry posting system tracks a posting status of the journal entries without writing or updating a flag of the posting status (e.g., a posting flag) in the journal entries every time that a journal entry is posted. Because such write operations would consume large amounts of computing resources compared to insertions, avoiding the management of flags greatly reduces consumption of computing resources and time. These reductions are magnified when the number of journal entries is in the order of billions, although the benefits are still there when the number is much lower.

In addition to efficiently tracking posting status, the journal entry posting system provides other computing improvements. The journal entry posting system posts the journal entries into the posting database, which may summarize a large corpus of journal entries. Summarizing provides a succinct view of relevant data within the journal entries, while greatly reducing the amount of computing resources that would otherwise be consumed in searching and retrieval of the journal entries. Summarizing also reduces the computing steps to perform downstream processes such as generating analytics or reports. Additionally, posting of the journal entries may include parallel processing of different subbatches of the journal entries. Parallel processing efficiently allocates available computing resources to post the journal entries while preventing overburdening, overheating or other malfunctioning of the computing resources. Moreover, the journal entries database implements an improved storage architecture. In this storage architecture, consumption records are partitioned into different storage partitions, which ensures security and efficient storage utilization among the different storage partitions. The journal entries themselves also have an improved storage format, which improves efficiency of retrieval of the journal entries.

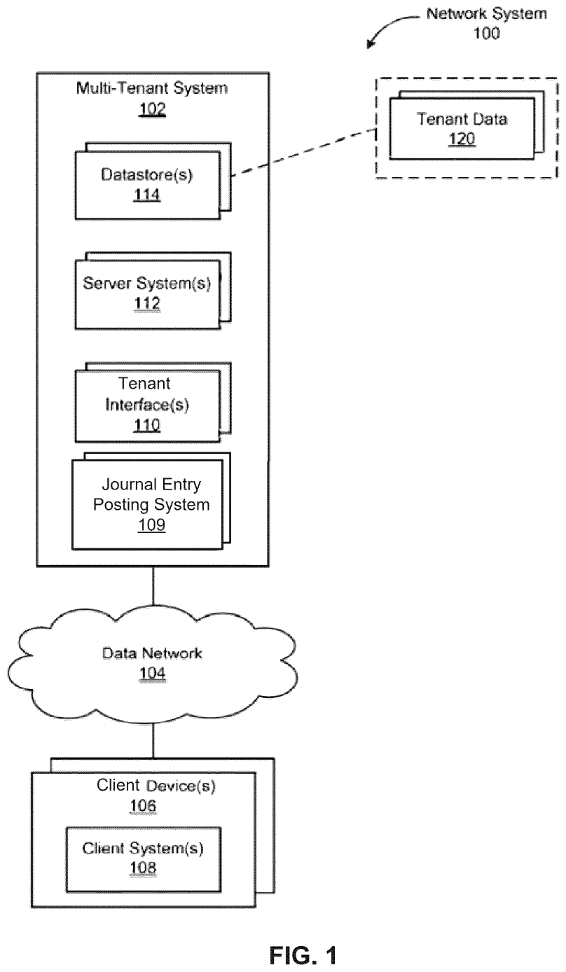

FIG. 1 is a block diagram of an example network system 100 for providing cloud-based software-as-a-service (SAAS) services of a multi-tenant system 102 to multiple tenants according to some embodiments. The teachings of FIG. 1 may be implemented in conjunction with any of the embodiments herein. Examples of cloud-based SAAS services include data storage, data processing, and business-oriented applications. In some embodiments, each tenant may be a subscription provider of resources (e.g., an internet service provider, a home security system or service provider, a cellular phone service provider, entertainment content provider, or provider of raw materials). Each tenant may additionally or alternatively include a group of one or more users (e.g., individuals, business entities, customers of the business entities, computing systems) who share access to the cloud-based services. In one embodiment, a tenant includes a service entity such as AT&T, Netflix, Verizon, or the like. A tenant may provide a subset of resources (e.g., products or services) of a larger entity. For example, AT&T internet products may be a particular tenant, and AT&T security products may be another tenant. In some embodiments, the cloud-based SAAS services include managing subscriber records, product or service consumption information, billing information, payment information, or the like.

The network system 100 includes the multi-tenant system 102 coupled via a data network 104 (e.g., a set of one or more public or private, wired or wireless networks) to client devices 106. The multi-tenant system 102 includes shared resources to host the cloud-based SAAS services to the tenants. The shared resources may include processors, memory, virtual systems, services, application programs, load balancers, firewalls, or the like. As shown, the multi-tenant system 102 includes tenant interfaces 110, server systems 112, datastores 114, and a journal entry posting system 109. Although the description focuses on journal entries, the invention is not to be construed to be limited to journal entries. The description may also apply to any other data such as multi-dimensional data. This data may include subscription records, billing records, consumption records, or other records or entries. Each of the client devices 106 includes a client system 108 that accesses the cloud-based SAAS services hosted by the multi-tenant system 102. In some embodiments, the client system 108 may be operated by employees (e.g., administrator users) of the provider of the multi-tenant system 102. In some embodiments, the client system 108 may be operated by employees of the tenant. In some embodiments, the client system 108 may be operated by end users (subscribers) of the tenant's services. In some embodiments, the client system 108 may be operated by computing systems.

Each client device 106 may include a desktop, laptop, notebook, tablet, personal digital assistant, smart phone, or other consumer electronic device incorporating one or more computer components. The client system 108 on each client device 106 may include hardware, software or firmware for communicating with the multi-tenant system 102 and accessing the cloud-based services it hosts. Examples of the client system 108 may include web browsers, client engines, drivers, user interface components, proprietary interfaces, or the like.

The multi-tenant system 102 includes hardware, software or firmware to host the cloud-based services for the tenants. It will be appreciated that the multi-tenant system 102 may offer access to shared resources including systems and applications on shared devices and offer each tenant the same quality or varying qualities of service. In some embodiments, the multi-tenant system 102 does not use virtualization or instantiation processes. In some embodiments, a multi-tenant system 102 integrates several business computing systems into a common system with a view toward streamlining business processes and increasing efficiencies on a business-wide level.

In some embodiments, the multi-tenant system 102 includes a user interface tier of multiple tenant interfaces 110, a server tier of multiple server systems 112, and a datastore tier of multiple datastores 114 for the multiple tenants. In some embodiments, the tenant interfaces 110 includes graphical user interfaces or web-based interfaces to enable tenants to access the shared services hosted by the multi-tenant system 102. The tenant interfaces 110 may support load balancing when multiple tenants (or multiple customers of the tenants) try to access the multi-tenant system 102 concurrently. The tenant interfaces 110 may additionally or alternatively include an operator interface for use by a systems operator to configure or otherwise manage the multi-tenant system 102. In some embodiments, tenants may input one or more customized entries using one or more customized fields, via the tenant interfaces 110 to be stored within datastores 114 and processed by the journal entry posting system 109. In some embodiments, each tenant may be associated with a subset of the total tenant interfaces 110 for load balancing. In some embodiments, within the tenant interfaces 110, tenants may provide customized entries related to customized event properties (e.g., a procurement channel or delivery channel of the resources, a tenant identifier, a sector of the resources, a country in which the resources were consumed or delivered from, a method of delivery, a unit of measure (UOM) of consumption).

In some embodiments, the server systems 112 include hardware, software or firmware to host the shared services for tenants. The hosted services may include tenant-specific business services or functions, including enterprise resource planning (ERP), customer relationship management (CRM), eCommerce, Human Resources (HR) management, payroll, financials, accounting, calendaring, order processing, subscription billing, inventory management, supply chain management (SCM), collaboration, sales force automation (SFA), marketing automation, contact list management, call-center support, web-based customer support, partner and vendor management systems, product lifecycle management (PLM), financial, reporting and analysis, or the like. Similar to the tenant interfaces 110, in some embodiments, the server systems 112 may support load balancing when multiple tenants (or multiple customers of tenants) try to access the multi-tenant system 102 concurrently. Further, in some embodiments, each tenant may be associated with a subset of the total server systems 112 for load balancing. In some embodiments, the journal entry posting system 109 includes hardware, software or firmware to post journal entries in real-time, at certain time periods, or in a scalable manner, in preparation for generating of downstream outputs such as analytics or reports. For example, depending on a quantity of journal entries, the journal entry posting system 109 may adjust a frequency of performing the aforementioned operations on the journal entries. Example frequencies may be every thirty minutes, every hour, every few hours, every day, every week, every month or any other frequency, or any other frequency.

In some embodiments, tenant data 120 for each tenant may be partitioned or stored in a logical store across one or more datastores 114. In some embodiments, each tenant uses a logical store that is not assigned to any predetermined datastores 114. Each logical store may contain tenant data 120 that is used, generated or stored as part of providing tenant-specific business services or functions. In some embodiments, the datastores 114 may include relational database management systems (RDBMS), MySQL relational database systems, object-based database systems, or the like. In some embodiments, tenant data 120 may be stored across multiple datastores 114, with each datastore dedicated to a particular service (e.g., managing customer records, managing subscription records, managing product or service consumption information, managing billing information, managing payment information, or the like). In some embodiments, any of the datastores 114 may store information regarding any updates or event notifications. In some examples, the tenant data 120 may originally have been ingested into the datastores 114 from different sources (e.g., servers that host resources being provisioned by a tenant).

In some embodiments, the datastores 114 may include one or more virtual stores, such as cloud-based stores. The datastores 114 may store data as objects within buckets, which are containers for the objects. Each of the objects may be linked to a key which uniquely identifies an object. The objects may contain object data and metadata. The metadata may include a set of name-value pairs that describe each object.

In some embodiments, the datastores 114 may store any or all of journal entries, batched journal entries, subbatched journal entries, staging tables, posting tables, invalidated journal entries, invalidated journal entries datasets, and any portions, intermediate outputs, or metadata thereof. In some embodiments the datastores 114 may include different storage partitions for security, easier access and faster retrieval.

In some embodiments, although the datastores 114, the server systems 112, the tenant interfaces 110, and the journal entry posting system 109 are shown separately, the separation is shown as merely an example of different aspects of the multi-tenant system 102. Any of the datastores 114, the server systems 112, the tenant interfaces 110, and the journal entry posting system 109 may be integrated together or communicate or collaborate with one another. For example, the server systems 112 and the journal entry posting system 109 may be integrated into a single system.

In some embodiments, the tenant data 120 may include records such as consumption records and subscription records. Subscription records include billing data, subscription status (e.g., active, canceled, suspended, re-activated), or geospatial data. In some embodiments, the tenant data 120 may include usage data (e.g., account activity data), such as new subscriptions, changes to subscribed products or services, cancellation of one or more products or services, subscriptions to new products or services, application of discounts, loyalty program package changes (e.g., additional programs or services, special rates, or the like for loyal customers), reduction or increase of rates for products or services, consumption records, or cancellation of the application. In some embodiments, account activity may include usage of a product or product of a subscriber (e.g., what programs or content the subscriber actually watches, what services and what level of consumption the subscriber receives, quality of the product or services, or the like). In some embodiments, the tenant data 120 may include any or all of journal entries, batched journal entries, subbatched journal entries, staging tables, posting tables, invalidated journal entries, invalidated journal entries datasets, and any portions, intermediate outputs, or metadata thereof. In some embodiments, the journal entries may be distinct from the consumption records and the subscription records. In some embodiments, creation of a journal entry may be triggered upon creation of a consumption record. In some embodiments, a journal entry may contain a subset of consumption data from a corresponding consumption record, such as a date or period of consumption and a consumption amount.

In some embodiments, the tenant data 120 may be stored in one or more data formats (or, simply, formats). For example, consumption records may be stored in a particular format, and journal entries may be stored in another format. As used herein, formats may include data types, variable types, protocols (e.g., protocols for accessing, storing, or transmitting data), programming languages, scripting languages, data value parameters (e.g., date formats, string lengths), endpoint locations or types, schemas, or the like.

In some embodiments, the tenant data 120 may be stored in one or more monolithic databases and in one or more custom field databases. As stated above, the tenant data 120 may be stored in different records, e.g., a subscription record, a consumption record, a billing record, etc. Each record may be managed by a particular record object, e.g., a subscription record object, a usage record object, a billing record object, etc. Each record object may manage a number of global fields that are common to all of the tenants. For example, the global fields for a subscription record for each and every tenant may include record ID, a username, a subscription identifier, etc. The global fields may be stored in the monolithic database. Notably, different tenants may require different additional fields to store information for different record objects.

For example, a first tenant may require two custom fields for a subscription record and one custom field for a consumption record. Another tenant may require three custom fields for a subscription record and four custom fields for a consumption record. Data for these custom fields can be stored in a custom field database for each record for each tenant.

The monolithic and custom field databases of the multi-tenant system 102 may manage (e.g., create, read, update, delete) tenant data 120 using different formats, different protocols, etc. A monolithic application will control data storage in the monolithic database. A custom field service (microservice) will control data storage in the custom field database. It will be appreciated that as used herein, a “service” may be single service or a set of services (e.g., a cluster of services).

The data network (or, communication network) 104 may represent one or more computer networks (e.g., LAN, WAN, or the like) or other transmission mediums. The data network 104 may provide communication between the systems, engines, datastores, components, or devices described herein. In some embodiments, the data network 104 includes one or more computing devices, routers, cables, buses, or other network topologies (e.g., mesh, and the like). In some embodiments, the data network 104 may be wired or wireless. In various embodiments, the data network 104 may include the Internet, one or more wide area networks (WANs) or local area networks (LANs), one or more networks that may be public, private, IP-based, non-IP based, and so forth.

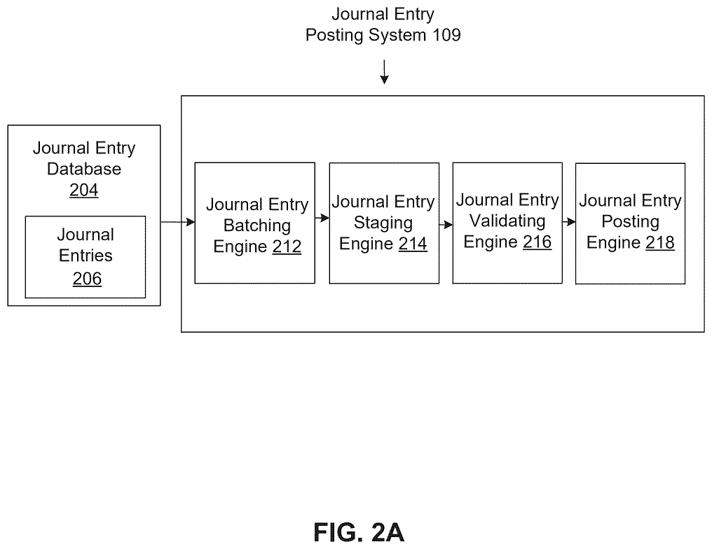

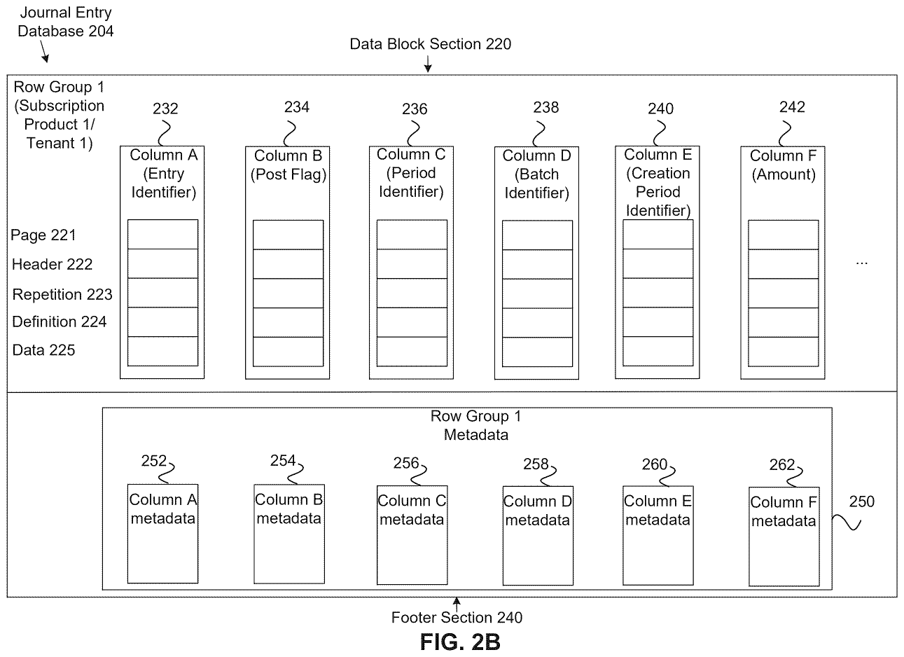

FIG. 2A is a diagram illustrating details of the journal entry posting system 109, in accordance with some embodiments of the present invention. The journal entry posting system 109 may include a journal entry batching engine 212, a journal entry staging engine 214, a journal entry validating engine 216, and a journal entry posting engine 218. The journal entry posting system 109 may include one or more services or microservices. The journal entry posting system 109 may separately perform the subsequently described actions for each given tenant. Although the foregoing describes the journal entry batching engine 212, the journal entry staging engine 214, the journal entry validating engine 216, and the journal entry posting engine 218, separately for ease of understanding, the invention is not to be construed as limited to such. In some embodiments, any of the aforementioned engines may be integrated. In some embodiments, additional engines may be implemented.

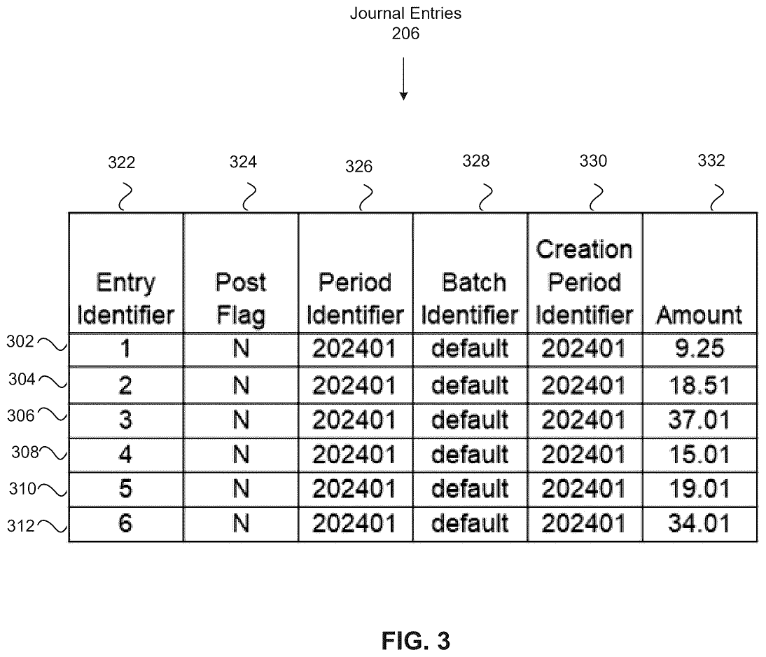

The journal entry batching engine 212 includes hardware, software or firmware configured to obtain one or more journal entries 206, or relevant subsets of journal entry attributes or journal entry attribute values from the journal entries 206. In some embodiments, the journal entry batching engine 212 may be configured to obtain the journal entries 206 via one or more Application Programming Interfaces (APIs). Examples of the journal entries 206 are illustrated in FIG. 3. In this disclosure, journal entries 206 may refer to an entirety or only a relevant portion of journal entry attributes or journal entry attribute values (e.g., one or more columns or rows corresponding to journal entry attributes). The journal entries 206 may be stored in a journal entry database 204, which may include a structured system. In some embodiments, the journal entry database 204 may constitute part of the datastores 114. An example implementation of the journal entry database 204 is illustrated in FIG. 2B.

In some embodiments, the journal entry batching engine 212 may efficiently retrieve relevant subsets of the journal entries 206 for posting. Efficient retrieval may be facilitated because certain journal entry attributes of the journal entries 206 may be mapped to specific locations (e.g., columns or rows) of the journal entry database 204. Additionally or alternatively, the journal entry batching engine 212 may query for journal entries 206 based on a temporal criteria, such as journal entries that belong to a specific time period such as a particular month or other range of times.

In some embodiments, as will be further illustrated in FIG. 2B, the journal entry database 204 may be organized in a columnar format or a hybrid format, or based on certain journal entry attributes. In some examples, for a given tenant, a first journal entry attribute value or a consumption event attribute value, such as a subscription product or subscriber, may be a basis for which the journal entries 206 are separated or mapped into different row groups. That is, journal entries 206 pertaining to different subscription products or different subscribers may be mapped to different row groups. Within each row group, different journal entry attribute values may be populated within particular columns. These journal entry attribute values may include a period identifier which identifies a period to which the journal entry belongs, or a metered attribute value such as a consumption amount. Thus, the journal entry batching engine 212 may retrieve relevant journal entry attribute values from the particular columns of one or more given row groups, and pertaining to a particular tenant. That is, within a single batching phase, the journal entry batching engine 212 would only retrieve journal entries of a single tenant. This avoids accessing of the entire journal entry database 204.

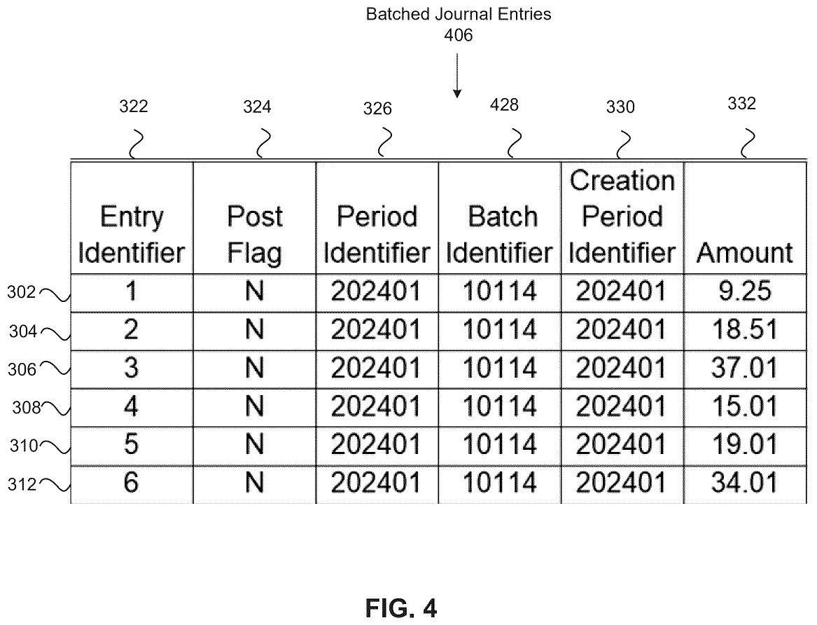

In some embodiments, the journal entry batching engine 212 may be configured to batch the journal entries 206. As illustrated in FIG. 4, batching may encompass assigning each journal entry 206, which satisfies some criteria, a particular batch identifier and generating a batch that constitutes the journal entries 206 having a same batch identifier. In some embodiments, prior to assigning a particular batch identifier, the batch identifier fields of the journal entries 206 may have an unassigned batch identifier value which may be a default identifier value such as “−1” as illustrated in FIG. 3. In some embodiments, an unassigned batch identifier value may signify that the journal entry 206 is unassigned to a particular batch. In some embodiments, prior to the batch identifier fields having an unassigned batch identifier value, the batch identifier fields may include null entries or have a null value.

In some embodiments, the assigning of the particular batch identifier may be based on a temporal attribute of the journal entry 206, such as a period of time to which the journal entry 206 belongs. Thus, any journal entries 206 satisfying a temporal criteria may be assigned a particular batch identifier at a given time instance, while other journal entries 206 that fail to satisfy the temporal criteria may remain unassigned to the particular batch identifier. In some embodiments, remaining unassigned to the particular batch identifier may mean that the other journal entries 206 retain their previous batch identifier, which may include the unassigned batch identifier, or a different batch identifier, without being reassigned to that particular batch identifier. For example, any journal entries 206 belonging to a first time period (e.g., a first month) would be assigned a first batch identifier at a first time instance while any journal entries 206 belonging to a different time period (e.g., a second month) would remain unassigned to the first batch identifier. Any journal entries 206 belonging to a second time period would be assigned a second batch identifier at a second time instance. Any journal entries 206 belonging to the first time period remain preassigned to the first batch identifier, and any journal entries belonging to a different time period would remain unassigned (e.g., assigned to the unassigned batch identifier). Also, as previously indicated, within a particular batch, the journal entries 206 belong to the same tenant. Thus, it is not possible to have different journal entries belonging to different tenants within a same batch.

In some embodiments, the journal entry batching engine 212 may be configured to maintain a record of any currently assigned (e.g., most recent assigned) batch identifier and historical assigned batch identifiers. If the journal entry batching engine 212 recognizes a particular journal entry as having a batch identifier that fails to match a currently assigned batch identifier, the journal entry batching engine 212 may recognize that the particular journal entry belongs to a previous batch, or has previously been posted, and refrains from incorporating the particular journal entry into a current batch to be posted. In this manner, the journal entry batching engine 212 prevents repeated posting of a same journal entry while ensuring that any current journal entry, which has not been posted yet, is posted. This process obviates the need to update a posting flag for every posted journal entry, which can be on the order of billions every hour. Updating a posting flag would involve write operations that consume large amounts of computing resources. Therefore, this process greatly reduces consumption of computing resources.

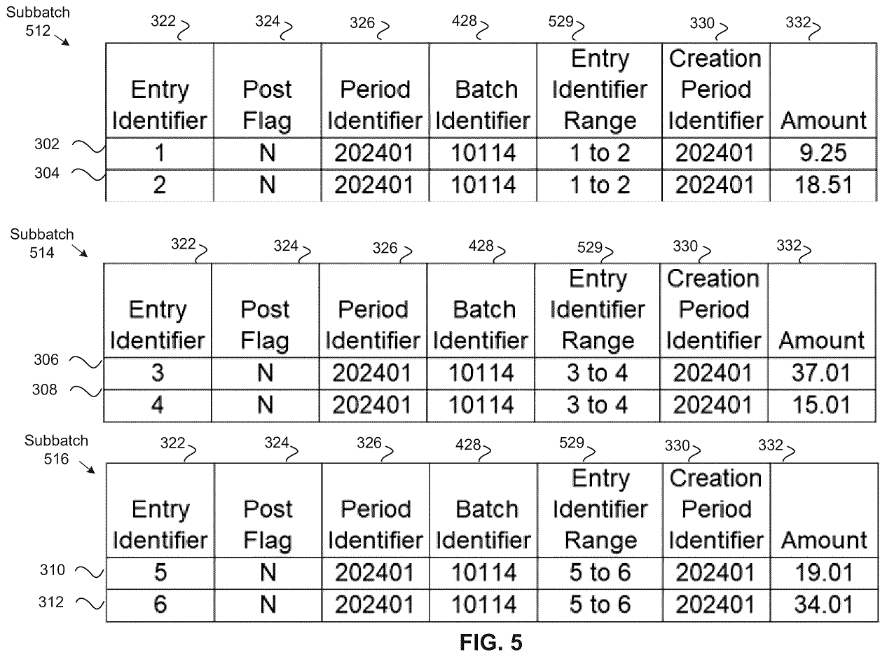

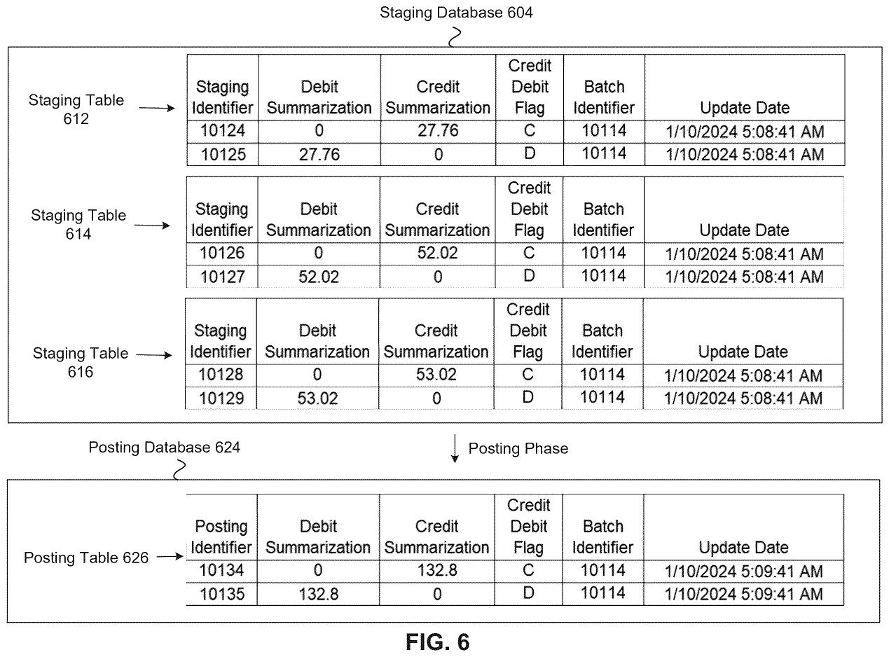

The journal entry staging engine 214 includes hardware, software or firmware configured to stage the batched journal entries. In some embodiments, staging may include dividing a batch to generating one or more subbatches within each batch, as illustrated in FIG. 5. In some embodiments, the journal entry staging engine 214 may perform transformations on each subbatch or otherwise generate one or more staging entries such as a staging table. Each generated staging table may correspond to each subbatch and may include a summary of each subbatch. For example, summarizing may include aggregating journal entry attribute values of a given journal entry attribute such as a metered attribute (e.g., consumption amount), as illustrated in FIG. 6. In some embodiments, summarizing may include creating staging table attributes and staging table attribute values corresponding to the aggregated journal entry attribute values. The staging table attributes may include a credit and a debit amount. Additionally or alternatively, summarizing may include performing other operations on the journal entry attribute values such as arithmetic operations. These arithmetic operations may include obtaining a mean, median, or mode across the journal entry attribute values. Each staging table may be inserted into a staging database, as illustrated in FIG. 6.

Staging confers technical benefits which include parallel processing of different subbatches of the journal entries. Parallel processing efficiently allocates available computing resources to generate intermediate results of posting, at least partially in parallel while preventing overburdening, overheating or other malfunctioning of the computing resources. Different computing resources such as different processors or services may generate different staging tables for different subbatches in parallel. In some embodiments, a number of subbatches may be adjusted dynamically based on availability of computing resources such as a number of different computing processors or other characteristics of the computing resources such as an available amount of memory or processing capability. For example, if ten computing processors are available at a given moment, then the journal entry staging engine 214 may separate a batch into ten subbatches. As another example, the generating of the subbatches may include determining a size (e.g., number of journal entries) of each subbatch, such that generating a staging table for each subbatch would consume under a threshold amount of time.

The journal entry validating engine 216 includes hardware, software or firmware configured to validate the journal entries 206. In some embodiments, at least part of the validating may occur prior to the posting of the journal entries 206. In some embodiments, validating may include ensuring that each subbatch or batch of the journal entries 206 has been successfully posted into the posting database. In some embodiments, validating may include logging any errors. In some embodiments, validating may include detecting any instance in which a journal entry 206 was unsuccessfully posted, for example due to corrupted or invalid journal entry attributes or journal entry attribute values, a schema mismatch or other incompatibility between the journal entry 206 and the posting database, or other errors. In some embodiments, upon detecting an invalidated journal entry, which was unsuccessfully posted, the journal entry validating engine 216 may generate a log for the invalidated journal entry. In some embodiments, the journal entry validating engine 216 may update the invalidated journal entry to indicate an unsuccessful posting status. In some embodiments, the updating of the invalidated journal entry field may include changing the batch identifier back to the default batch identifier such as “−1,” or a different value that has not been previously used as a batch identifier value.

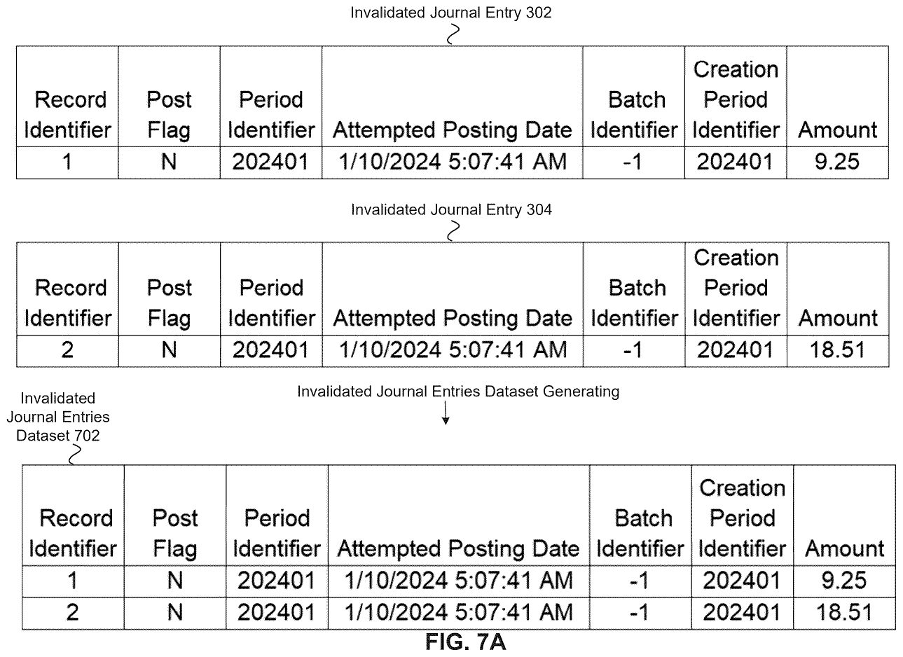

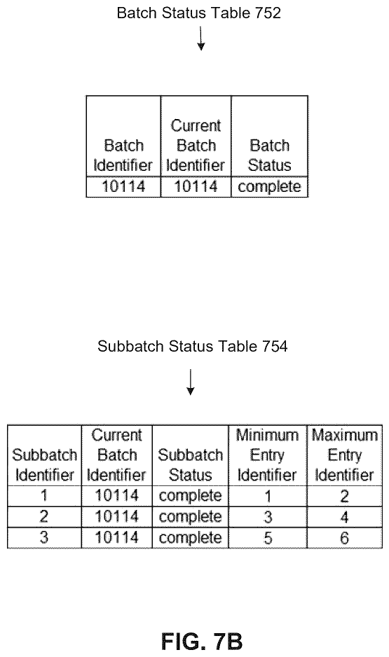

During a subsequent batching phase, the journal entry batching engine 212 would refrain from reassigning the invalidated journal entry a batch identifier, because of recognition that the invalidated journal entry belongs to a previous time period. In some embodiments, the journal entry validating engine 216 may be configured to generate an invalidated journal entries dataset that includes any or all of invalidated journal entries within a particular batch or subbatch, as illustrated in FIG. 7A. In some embodiments, the journal entry validating engine 216 may be configured to update within one or more batch status tables and subbatch status tables, a posting and staging status of one or more batches or subbatches, as illustrated in FIG. 7B.

The journal entry posting engine 218 includes hardware, software or firmware configured to post the journal entries 206. In some embodiments, posting may include transforming the staging tables constituting a given batch into a posting table, or otherwise generating a posting table using the staging tables, and inserting the posting table into a posting database, as illustrated in FIG. 6. In some embodiments, generating the posting table may include aggregating, across the staging tables, staging table attribute values of a given staging table attribute such as credit and debit amount. Additionally or alternatively, generating the posting table may include performing other operations on the staging table attribute values such as arithmetic operations. The posting table provides a summary across potentially billions of journal entries. In some embodiments, the posting table may be retrieved or referenced for downstream processes such as generating of analytics or reports.

FIG. 2B is a diagram illustrating details of the journal entry database 204, in accordance with some embodiments of the present invention. FIG. 2B merely illustrates one example of a journal entry database. Other organizations or types of journal entry databases are also contemplated. Other formats and manners of storage of the journal entries 206 are also contemplated. In some embodiments, the journal entry database 204 may store the journal entries 206 in a structured format such as a columnar or hybrid format. A hybrid format may refer to a format that includes one or more row representation (e.g., row groups) and one or more column representations. In some embodiments, the journal entries 206 may be at least partially compressed or encoded at least partially prior to being stored in the journal entry database 204. In some embodiments, the journal entries 206 may include or be embedded with metadata, or the journal entry database 204 may store metadata associated with the journal entries 206.

In some embodiments, the journal entry database 204 may include or be represented as multiple sections such as a data block section 220 that includes data corresponding to the journal entries 206 and a footer section 240 that includes associated metadata. In the example illustrated in FIG. 2B, the data block section 220 includes different row groups or blocks. In some embodiments, the different row groups may correspond to different subscription products of a same tenant or subtenant. In other embodiments, the different row groups may correspond to different tenants or subtenants. The data block section 220 may include, within a particular row group, one or more columns. In the example shown in FIG. 2B, the data block section 220 may include a first column 232 labelled as “Column A,” a second column 234 labelled as “Column B,” a third column labelled as “Column C,” a fourth column labelled as “Column D,” a fifth column labelled as “Column E,” a sixth column labelled as “Column F,” and so on. Each column may include any or all of a page 221 identifying a relative location within the journal entries 206, a header 222 identifying a name or a path of the journal entries 206, a repetition level 223 identifying or distinguishing between different repeated data entries (e.g., repeated journal entry attribute values), a definition level 224 that defines any optional fields (e.g., optional journal entry attributes), and data 225 which may include a journal entry attribute value. The repetition level 223 and the definition level 224 may provide for efficient storage and retrieval, by avoiding separate storage of any repeated data entries while still recording separate instances of the repeated data entries. In some embodiments, the data 225 in each column may correspond to a particular journal entry attribute value. In some examples, the data 225 corresponding to the fourth column 238 and the sixth column 242 may include the batch identifier and the amount, respectively. This mapping of a particular journal entry attribute value to a particular column also facilitates a fast response time of retrieval because only one or more particular columns that are relevant to a query or otherwise relevant to posting need to be accessed, rather than an entirety of the journal entry database 204. For example, if posting requires aggregating amounts for a given batch identifier, then the fourth column 238 and the sixth column 242 are accessed, without accessing other columns or row groups that are irrelevant to the query. Initially, prior to the journal entry batching engine 212 assigning batch identifiers, the batch identifier attribute value may be a default batch identifier such as “−1.”

The footer section 240 may include metadata of the journal entries 206. The metadata may include metadata 250, 260 for each row group, or metadata 252, 254, 262 for each column. In some embodiments, metadata may indicate a schema of the journal entries 206, types of the data (e.g., integer, string, Boolean, float, double, array), any encoding within the journal entries 206, or any offsets that indicate a mapping of pages within journal entries 206 to particular rows. The metadata may include, as nonlimiting examples, metrics such as minimum values or maximum values. The presence of metadata further improves efficiency of data retrieval because, from the metadata, the journal entry batching engine 212 may determine certain columns or row groups as relevant or irrelevant. Thus, the journal entry batching engine 212 may access fewer locations (e.g., columns or row groups) within the journal entry database 204 in order to retrieve relevant journal entries.

Storing in a columnar or hybrid format has technical benefits of higher compression ratios which reduces storage requirements. Another technical benefit includes skipping of irrelevant columns. Another technical benefit includes flexible addition of new columns or changes to existing columns without disrupting existing data. Another technical benefit includes efficient encoding of data when storing data within the journal entry database 204.

In some embodiments, the journal entry database 204 may contain different partitions. In some embodiments, the different partitions may correspond to the different row groups or may be partitioned based on other partitioning criteria. In some embodiments, partitioning includes security partitioning to prevent certain data transmission or data flow among different partitions. Partitioning may include physical or logical partitions within the journal entry database 204 or within memory components or other components. In some embodiments, partitioning encompasses routing each of the journal records 206, or portions thereof, to a particular storage partition. In some embodiments, storage partitions may include directories or folders within the journal entry database 204. In some embodiments, the storage partitions include tenant level partitions, each of which is configured to store journal entries of a particular tenant or subtenant. In some embodiments, the storage partitions may, additionally or alternatively, include temporal level partitions, each of which is configured to store consumption records having a particular temporal attribute (e.g., a day or a time period). In some embodiments, the temporal level partitions may be sub-directories that are hierarchically organized under one of the tenant level directories.

Partitioning based on tenant identifier and temporal attributes facilitates efficient retrieval of relevant journal entries. For example, to obtain the relevant journal entries for a given time period and for a particular tenant, only a particular temporal level partition (e.g., sub-directory) within a tenant level directory needs to be accessed, instead of accessing the entire datastore 114 or the entire journal entry database 204. Moreover, such partitioning also ensures security by preventing data from being shared among different tenants. Journal entries corresponding to different tenants may also have different metadata, such as security settings (e.g., access control restrictions or dissemination restrictions). By segregating the journal entries of different tenants, these tenant-specific security settings may be enforced in each of the different storage partitions. In other embodiments, partitioning may additionally or alternatively be based on other criteria such as a schema of the journal entries. A schema may refer to a subset or all of the journal entry attributes illustrated in FIG. 3.

FIG. 3 is a diagram illustrating example journal entries 206. In FIG. 3, example journal entries 302, 304, 306, 308, 310, and 312 may be implemented as the journal entries 206 of FIG. 2. In FIG. 3, although only six journal entries are illustrated, in a particular scenario, a number of journal entries may be on the order of billions. The journal entries 302, 304, 306, 308, 310, and 312 may include journal entry attributes 322, 324, 326, 328, 330, and 332 corresponding to entry identifier, posting flag, period identifier, batch identifier, creation period identifier, and amount, respectively. In some embodiments, the journal entries 206 may include additional or fewer journal entry attributes. In some embodiments, additional journal entry attributes may include tenant name, tenant identifier, consumption subscriber, consumption subscription identifier, subscription product, unit of measure (UOM) of consumption, posting date (e.g., when the journal entry was posted to the posting table), industry sector, a method by which subscription resources were requested, a country in which the subscription resources were consumed, or a consumption channel, and other journal entry attributes.

The entry identifier 322 may correspond to a primary key, and may uniquely identify and distinguish each separate journal entry that belongs to a given time period. The posting flag 324 may identify a status of whether the journal entry has been posted to the posting table. In some embodiments, the posting flag 324 may include two possible values, “Y” or “N” which identify that the journal entry has or has not been posted. The period identifier 326 may identify a particular period that the journal entry belongs to, such as a particular month. The batch identifier 328 may identify an assigned batch of the journal entry, as described with respect to the journal entry batching engine 312. In some embodiments, an unassigned batch identifier, such as “−1,” may be populated in each journal entry prior to the journal entry batching engine 212 assigning a batch identifier. The creation period identifier 330 may identify a particular creation period of the journal entry. In some embodiments, the creation period identifier 330 may have a same value as the period identifier 326. The amount 332 may identify a transaction amount which may correspond to one or more consumption events.

FIG. 4 is a diagram illustrating batched journal entries, in accordance with some embodiments of the present invention. In some embodiments, the journal entry batching engine 212 assigns batch identifiers, and populates the assigned batch identifiers within updated fields 428 (e.g., columns) of batched journal entries 406. Here, the journal entry batching engine 212 has assigned batch identifiers of value “10114” to the journal entries 302, 304, 306, 308, 310, and 312. The fact that the journal entries 302, 304, 306, 308, 310, and 312 have been assigned same batch identifiers may indicate that the journal entries 302, 304, 306, 308, 310, and 312 belong to a same batch. In some embodiments, assigning of batch identifiers may be based on a temporal criteria. Thus, the journal entries 302, 304, 306, 308, 310, and 312 belonging to a same batch may mean that the journal entries 302, 304, 306, 308, 310, and 312 belong to a same time period, as identified by the period identifier attribute 326. In some embodiments, each batch identifier corresponding to a different time period may have a unique value. That is, the assigned batch identifiers within the fields 428 may be different from any other batch identifier from a previous time period and from a future time period. The assigned batch identifier may be used by the journal entry batching engine 212 to generate a batch that includes any journal entries having the same batch identifier, which includes at least the journal entries 302, 304, 306, 308, 310, and 312 in FIG. 4. Any journal entries that have a different batch identifier would be excluded from the batch. Therefore, assigning batch identifiers allows efficient recognition, by the journal entry batching engine 212, of journal entries to include within a given batch. Assigning of batch identifiers also avoids erroneous inclusion of other journal entries having different batch identifiers which have already been previously posted or attempted to be posted. Moreover, the assigning of the batch identifiers avoids computationally intensive updates to individual journal entries after staging or posting.

FIG. 5 is a diagram illustrating subbatched journal entries, in accordance with some embodiments of the present invention. In FIG. 5, the journal entry staging engine 214 divides the batch corresponding to the batch identifier “10114” into subbatched journal entries (hereinafter “subbatches”) 512, 514, and 516. Each subbatch may have a different entry identifier range 529, which identifies a range of entries present in that subbatch. Here, the subbatch 512 may include the journal entries 302 and 304, which have an entry identifier range of 1 to 2. The subbatch 514 may include the journal entries 306 and 308, which have an entry identifier range of 3 to 4. The subbatch 516 may include the journal entries 310 and 312, which have an entry identifier range of 5 to 6. Dividing a batch into subbatches facilitates parallel processing of each subbatch, which may be performed by a different computing process or service. Parallel processing of each subbatch increases efficiency of posting while effectively allocating available computing resources.

FIG. 6 is a diagram illustrating an example of part of a staging phase and posting phase, in accordance with some embodiments of the present invention. In FIG. 6, the journal entry staging engine 214 may generate one or more staging entries, which may be included in or represented as a staging table, for each subbatch. Specifically, the journal entry staging engine 214 may generate a staging table 612 for the subbatch 512, a staging table 614 for the subbatch 514, and a staging table 616 for the subbatch 616. As previously alluded to, each staging table 612, 614, 616 may be generated by a different computing process at least partially in parallel for efficiency. Each staging table may be an intermediate result. The journal entry staging engine 214 may insert each staging table into a staging database 604. Each of the staging tables 612, 614, and 616 may include staging table attributes. The staging table attributes may include a staging identifier, a staging debit summarization or staging debit summary, a staging credit summarization or staging credit summary, a staging credit debit flag, the batch identifier, and a staging update date. In other embodiments, all staging entries may be included in a single staging table, rather than separate staging tables 612, 614, and 616.

The staging identifier may uniquely identify each staging entry, such as a debit summarization or a credit summarization. The staging debit summarization and the staging credit summarization may be obtained by summarizing one or more journal entry attribute values across the journal entries within each subbatch. In some embodiments, summarizing may include aggregating the amount 332 across the journal entries within each subbatch. In some embodiments, additionally or alternatively, summarizing may include performing other operations such as arithmetic operations across one or more journal entry attribute values corresponding to the journal entries within each subbatch. In the example of FIG. 6, the staging debit summarization and staging credit summarization corresponding to the staging identifiers “10124” and “10125” are obtained by aggregating the journal entry attribute values of the amount 332 across the journal entries 302 and 304. Since these journal attribute values are “9.25” and “18.51,” which add up to “27.76,” the staging debit summarization and staging credit summarization are each “27.76.” Similarly, the staging debit summarization and staging credit summarization corresponding to the staging identifiers “10126” and “10127” are obtained by aggregating the amount 332 across the journal entries 306 and 308 within the subbatch 514. This aggregated amount is “52.02.” Similarly, the staging debit summarization and staging credit summarization corresponding to the staging identifiers “10128” and “10129” are obtained by aggregating the amount 332 across the journal entries 310 and 312 within the subbatch 516. This aggregated amount is “53.02.”

The staging credit debit flag may identify whether the given staging entry corresponds to a debit or a credit, which may be indicated by “D” or “C,” in some embodiments. For example, the staging entry corresponding to the staging identifier “10124” corresponds to a credit while the staging entry corresponding to the staging identifier “10125” corresponds to a debit. The batch identifier may be obtained from the journal entries 206. The staging update date may identify a date or time at which the staging entry, or the staging table 612, 614, or 616, was generated.

FIG. 6 also illustrates a posting phase, in which the journal entry posting engine 218 may generate one or more posting entries which may be included in or represented as a posting table 626. The posting table 626 may be generated based on a summary of the staging tables 612, 614, and 616, or alternatively, a summary of the journal entries 302, 304, 306, 308, 310, and 312. The journal entry posting engine 218 may insert the posting table 626 into a posting database 624. The posting table 626 may include posting table attributes. The posting table attributes may include a posting identifier, a posting debit summarization or posting debit summary, a posting credit summarization or posting credit summary, a posting credit debit flag, the batch identifier, and a posting update date.

The posting identifier may uniquely identify each posting entry, such as a posting debit summarization or a posting credit summarization. The posting debit summarization and the posting credit summarization may be obtained by summarizing the staging debit summarizations and the staging credit summarizations across the staging tables 612, 614, and 616. In some embodiments, summarizing may include aggregating the staging debit summarizations and the staging credit summarizations. In some embodiments, additionally or alternatively, summarizing may include performing other operations such as arithmetic operations across the staging debit summarizations and the staging credit summarizations. In the example of FIG. 6, the posting debit summarization and the posting credit summarization are obtained by aggregating “27.76,” “52.02,” and “53.02,” which amounts to “132.8.”

The credit debit flag may identify whether the given posting entry corresponds to a debit or a credit, which may be indicated by “D” or “C,” in some embodiments. For example, the posting entry corresponding to the posting identifier “10134” corresponds to a credit while the posting entry corresponding to the staging identifier “10135” corresponds to a debit. The batch identifier may be obtained from the journal entries 206. The posting update date may identify a date or time at which the posting entry, or the posting table 624, was generated.

After posting, the batched journal entries 406 may be maintained without updating individual entries such as the batch identifiers 428 or the posting flags 324. This avoids computationally intensive operations to individual journal entries especially when a number of journal entries is on an order of billions.

FIG. 7A is a diagram illustrating invalidated journal entries and generating of an invalidated journal entries dataset, in accordance with some embodiments of the present invention. In FIG. 7A, assume a scenario in which the journal entry validating engine 216 determines that the journal entries 302 and 304 are invalidated. In some embodiments, an invalidated journal entry may mean an unsuccessful attempt at posting of the invalid journal entries. For example, this unsuccessful attempt may be due to a journal entry attribute or journal entry attribute value being corrupt or nonconforming, such as not conforming to one or more format or range requirements. In some embodiments, the journal entry validating engine 216 may update the invalidated journal entries 302 and 304 to indicate an unsuccessful posting status. In some embodiments, the updating may include changing the batch identifier back to the default batch identifier such as “−1,” or a different value that has not been used as a batch identifier value. During a subsequent batching phase, the journal entry batching engine 212 would refrain from reassigning the invalidated journal entries 302 and 304 a batch identifier, because of recognition that the invalidated journal entry belongs to a previous time period as indicated by the period identifier of “202401.” In some embodiments, the journal entry validating engine 216 may be configured to generate an invalidated journal entries dataset 702 that includes any or all of the invalidated journal entries 302 and 304 within a particular batch or subbatch. In some embodiments, the invalidated journal entries dataset 702 may undergo a modification such as a debugging, and may be attempted to be posted again.

FIG. 7B is a diagram illustrating an example batch status table and an example subbatch status table, to track posting statuses of batches and subbatches, in accordance with some embodiments of the present invention. In FIG. 7B, the journal entry validating engine 216 may generate a batch status table 752 which includes a batch identifier, a current batch identifier that identifies a current batch that is undergoing posting or has most recently undergone posting, and a status of the batch corresponding to the batch identifier. In some embodiments, a current batch having undergone posting may mean that the entire batch has been successfully validated. In some embodiments, a current batch having undergone posting may mean that any error or invalid journal entries have been detected and logged, or that an invalidated journal entries dataset has been generated. In some embodiments, if the batch status table 752 pertains to a previous batch, then the batch identifier would correspond to the previous batch, which would differ from the current batch identifier. In some embodiments, if the batch status table 752 pertains to a current batch, then the current batch identifier would match the batch identifier. In some embodiments, the status of the batch may include any of a completed status, an incomplete status, an error status, a validity status which may include any invalidated journal entries, or a level of progression of posting. In some embodiments, the current batch identifier for the batch status table 752 may be updated every time that a new current batch undergoes posting or has completed posting.

The journal entry validating engine 216 may generate a subbatch status table 754 which includes a subbatch identifier, the current batch identifier that identifies a current batch that is undergoing posting or has most recently undergone posting, a status of the subbatch corresponding to the subbatch identifier, a minimum subbatch entry identifier, and a maximum subbatch entry identifier. In the example of the subbatch status table 754, the subbatch corresponding to the subbatch identifier “1” includes entry identifiers within a range from “1” to “2,” inclusive, as illustrated previously in the example of FIG. 5. The subbatch corresponding to the subbatch identifier “2” includes entry identifiers within a range from “3” to “4,” inclusive, as illustrated previously in the example of FIG. 5. The subbatch corresponding to the subbatch identifier “3” includes entry identifiers within a range from “5” to “6,” inclusive, as illustrated previously in the example of FIG. 5. In some embodiments, the status of the subbatch may include any of a completed status, an incomplete status, an error status, a validity status which may include any invalidated journal entries, or a level of progression of posting. In some embodiments, the current batch identifier for the subbatch status table 754 may be updated every time that a new current batch undergoes posting or has completed posting.

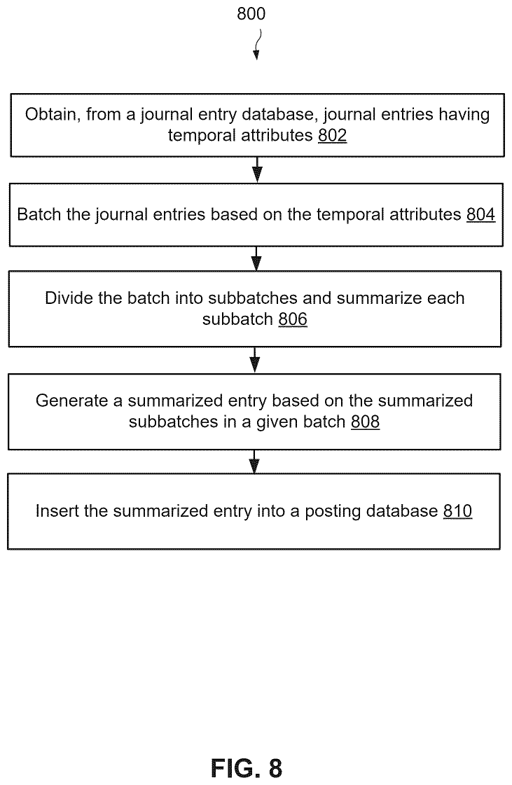

FIG. 8 is a flowchart of a method of posting journal entries into a journal entry posting database, in accordance with some embodiments of the present invention. The method may include one or more batching phases and one or more posting phases. In step 802, the journal entry batching engine 212 may obtain the journal entries 206 from the journal entry database 204. Examples of the journal entries 206 may include the journal entries 302, 304, 306, 308, 310, and 312 as illustrated in FIG. 3. The journal entries 206 may contain journal entry attributes such as a temporal attributes, which include a period identifier that identifies a time period to which each of the journal entries belongs, a batch identifier, and one or more metered attributes such as a consumption amount. A default batch identifier may be populated into the respective batch identifier fields of the journal entries, as illustrated in FIG. 3.

In step 804, the journal entry batching engine 212 may batch the journal entries based on their temporal attributes. In some embodiments, batching the journal entries may include determining, for each individual journal entry, whether the corresponding temporal attributes satisfy a temporal criteria. In some embodiments, the temporal criteria may include the journal entry having a period identifier that satisfies a given value or range of values. For example, the journal entry may have a period identifier that corresponds to a most recent, or current, time period, such as “202401” during a time period of January 2024, referring to FIG. 3. In some embodiments, any journal entries that have the default batch identifier in the batch identifier field, and satisfy the temporal criteria, such as the journal entries 302, 304, 306, 308, 310, and 312, are considered temporally conforming journal entries. For any temporally conforming journal entries, the journal entry batching engine 212 generates a batch identifier and assigns those journal entries to the batch identifier, or the batch that corresponds to the batch identifier. In some embodiments, assigning the batch identifier may include replacing the default batch identifier with the assigned batch identifier, as illustrated in FIG. 4. Therefore, a batch may include any journal entries having a same batch identifier. Any temporally nonconforming journal entries, which have the default batch identifier but have temporal attributes failing to satisfy the temporal criteria, are excluded from the batch. Examples of temporally nonconforming journal entries would include any journal entries that have the default batch identifier but have a different period identifier than “202401” during a time period of January 2024.

In step 806, the journal entry staging engine 214 may divide the batch into subbatches, as illustrated in FIG. 5, and summarize each subbatch, as illustrated in FIG. 6. In some embodiments, summarizing each subbatch may include aggregating the metered amounts across the journal entries within each subbatch, as illustrated for example in FIG. 6. In some embodiments, summarizing different subbatches may be performed at least partially in parallel. That is, a computing process may summarize a first subbatch (e.g., the subbatch 512), and a different computing process may summarize a second subbatch (e.g., the subbatch 514). In some embodiments, one or more staging entries which may be included in or represented as a staging table (e.g., the staging table 612, 614, or 616) may be generated based on each summarized subbatch. In some embodiments, only one staging table may be generated for all the summarized subbatches.

In step 808, the journal entry posting engine 218 may generate a summarized entry, such as a posting table, based on the staging tables of the different subbatches. In step 810, the journal entry posting engine 218 may insert the posting table into a posting database, as illustrated for example in FIG. 6. In some embodiments, steps 802, 804, and 806 may constitute a batching phase while steps 808 and 810 may constitute a posting phase. In some embodiments, distinguishing between a batching phase and posting phase may result in more efficient allocation of computing resources so that the computing resources are prevented from being overburdened during the posting phase. In some embodiments, alternatively, step 806 may constitute a staging phase or part of a staging phase.

In some embodiments, to illustrate batching and posting over different, nonoverlapping time periods, such as a first month (e.g., January) and a second month (e.g., February), the batching phase comprises a first batching phase, and the posting phase comprises a first posting phase. In some embodiments, the temporal criteria comprises a first temporal criteria, for example, that the period identifier corresponds to or satisfies a first time period (e.g., January). In some embodiments, the journal entries comprise first journal entries, and the temporally conforming journal entries comprise temporally conforming first journal entries. In some embodiments, the batch identifier fields comprise first batch identifier fields, the assigned batch identifier comprises a first assigned batch identifier (e.g., “202401”), and the batch comprises a first batch. In some embodiments, the first batch includes any journal entries that satisfy the first temporal criteria (e.g., created during or corresponding to a first particular time period, such as the first month). In some embodiments, the summarized entry comprises a first summarized entry. In some embodiments, during a second batching phase that occurs during a second time period (e.g., February), the journal entry batching engine 212 obtains, from the journal entry database, second journal entries having corresponding second temporal attributes. The operations include, populating, into respective second batch identifier fields of the second journal entries, the default batch identifier and determining individually whether each of the second temporal attributes satisfy a second temporal criteria. For example, this includes determining whether the second journal entries have respective period identifiers that correspond to or satisfy the second time period (e.g., February). For any temporally conforming second journal entries, which have the default batch identifier and have second temporal attributes satisfying the second temporal criteria: the journal entry batching engine 212 generates an assigned second batch identifier (e.g., “202402”) distinct from the first batch identifier. The second batch identifier is assigned to the any temporally conforming second journal entries. For those temporally conforming second journal entries, the journal entry batching engine 212 replaces the default batch identifier (e.g., an unassigned batch identifier) with the assigned second batch identifier; and assigns the any temporally conforming second journal entries into the second batch. In some embodiments, the second batch includes any journal entries that satisfy the second temporal criteria (e.g., created during or corresponding to a second particular time period, which may be subsequent to and nonoverlapping with the first particular time period, such as a second month). The operations include, determining, based on the temporally conforming first journal entries being assigned the first batch identifier distinct from the second batch identifier, that the temporally conforming first journal entries have already been posted.

Thus, the temporally conforming first journal entries would not be posted again. The operations include, during a second posting phase, generating a second summarized entry based on the any temporally conforming second journal entries within the batch, and inserting the second summarized entry into the posting database.

In some embodiments, for any temporally nonconforming second journal entries, which have the default batch identifier and have second temporal attributes failing to satisfy the second temporal criteria, the journal entry validating engine 216 may flag the temporally nonconforming second journal entries and generate the invalidated journal entries dataset based on the flagged journal entries.

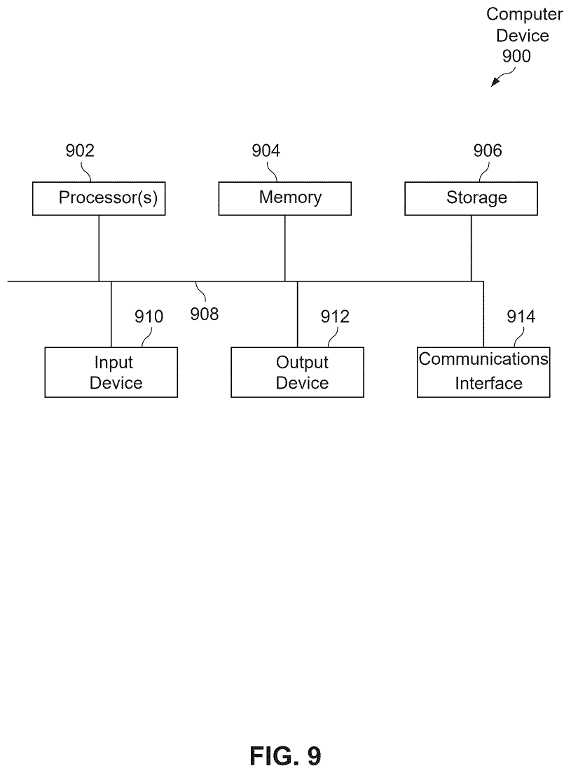

FIG. 9 is a block diagram of a computing device 900. Any of the systems, engines, datastores, or networks described herein may comprise an instance of one or more computing devices 900. In some embodiments, functionality of the computing device 900 is improved to perform some or all of the functionality described herein. The computing device 900 comprises a processor 902, memory 904, storage 906, an input device 910, a communication network interface 914, and an output device 912 communicatively coupled to a communication channel 908. The processor 902 is configured to execute executable instructions (e.g., programs). In some embodiments, the processor 902 comprises circuitry or any processor capable of processing the executable instructions.

The memory 904 stores data. Some examples of memory 904 include storage devices, such as RAM, ROM, RAM cache, virtual memory, etc. In various embodiments, working data is stored within the memory 904. The data within the memory 904 may be cleared or ultimately transferred to the storage 906.

The storage 906 includes any storage configured to retrieve and store data. Some examples of the storage 906 include flash drives, hard drives, optical drives, cloud storage, or magnetic tape. In some embodiments, storage 906 may include RAM. Each of the memory 904 and the storage 906 comprises a computer-readable medium, which stores instructions or programs executable by processor 902.

The input device 910 may be any device that inputs data (e.g., mouse and keyboard). The output device 912 may be any device that outputs data or processed data (e.g., a speaker or display). It will be appreciated that the storage 906, input device 910, and output device 912 may be optional. For example, the routers/switchers may comprise the processor 902 and memory 904 as well as a device to receive and output data (e.g., the communication network interface 914 or the output device 912).

The communication network interface 914 may be coupled to a network (e.g., the network system 100) via the link 908. The communication network interface 914 may support communication over an Ethernet connection, a serial connection, a parallel connection, or an ATA connection. The communication network interface 914 may also support wireless communication (e.g., 802.11 a/b/g/n, WiMax, LTE, WiFi). It will be apparent that the communication network interface 914 may support many wired and wireless standards.

It will be appreciated that the hardware elements of the computing device 900 are not limited to those depicted. A computing device 900 may comprise more or less hardware, software or firmware components than those depicted (e.g., drivers, operating systems, touch screens, biometric analyzers, or the like). Further, hardware elements may share functionality and still be within various embodiments described herein. In one example, encoding or decoding may be performed by the processor 902 or a co-processor located on a GPU (i.e., NVidia).

It will be appreciated that an “engine,” “system,” “datastore,” or “database” may comprise software, hardware, firmware, service, microservice, or circuitry. In one example, one or more software programs comprising instructions capable of being executable by a processor may perform one or more of the functions of the engines, datastores, databases, or systems described herein. In another example, circuitry may perform the same or similar functions. Alternative embodiments may comprise more, less, or functionally equivalent engines, systems, datastores, or databases, and still be within the scope of present embodiments. For example, the functionality of the various systems, engines, datastores, or databases may be combined or divided differently. The datastore or database may include cloud storage. It will further be appreciated that the term “or,” as used herein, may be construed in either an inclusive or exclusive sense. Moreover, plural instances may be provided for resources, operations, or structures described herein as a single instance. It will be appreciated that the term “request” shall include any computer request or instruction, whether permissive or mandatory.

The databases/datastores described herein may be any suitable structure (e.g., an active database, a relational database, a self-referential database, a table, a matrix, an array, a flat file, a documented-oriented storage system, a non-relational No-SQL system, and the like), and may be cloud-based or otherwise. References to objects may refer to data representations that include fields or attributes that define the data.

The systems, methods, engines, datastores, or databases described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component.

Similarly, structures and functionality presented as a single component may be implemented as separate components. These and other variations, modifications, additions, and improvements fall within the scope of the subject matter herein.

Reference to A “and” B may be construed to also encompass the scenario of A “or” B. Reference to A “or” B may be construed to also encompass the scenario of A “and” B. Any reference to “near,” a “threshold” or “sufficiency” may be construed to encompass any applicable value or degree, such as any applicable value or degree sufficient to satisfy a given outcome. In some examples, a threshold level, similarity or degree thereof may be construed to include any values such as 99 percent, 98 percent, 95 percent, 90 percent, 80 percent, 75 percent, or any other value therebetween, or any ranges therebetween. Additionally or alternatively, a threshold similarity, degree, or level may be construed as qualitatively satisfying some condition.

The phrases “at least one of,” “at least one selected from the group of,” or “at least one selected from the group consisting of,” and the like are to be interpreted in the disjunctive (e.g., not to be interpreted as at least one of A and at least one of B).

The present invention(s) are described above with reference to example embodiments. It will be apparent to those skilled in the art that various modifications may be made and other embodiments may be used without departing from the broader scope of the present invention(s). Therefore, these and other variations upon the example embodiments are intended to be covered by the present invention(s).

1. A multi-tenant system, comprising:
one or more hardware processors; and
memory storing computer instructions, the computer instructions when executed by the one or more hardware processors configured to perform:
during a batching phase,
obtaining, from a journal entry database, journal entries having corresponding temporal attributes;
populating, into respective batch identifier fields of the journal entries, a default batch identifier;
determining individually whether each of the temporal attributes satisfy a temporal criteria;
for any temporally conforming journal entries, which have the default batch identifier and have temporal attributes satisfying the temporal criteria:
generating an assigned batch identifier;
replacing the default batch identifier with the assigned batch identifier; and
assigning the any temporally conforming journal entries into the batch while excluding from the batch any temporally nonconforming journal entries, which have the default batch identifier and have temporal attributes failing to satisfy the temporal criteria; and
during a posting phase,
generating a summarized entry based on the any temporally conforming journal entries within the batch; and
inserting the summarized entry into a posting database.

2. The multi-tenant system of claim 1, wherein the temporal attributes comprise or identify respective time periods that the journal entries belong to, and the temporal criteria is satisfied based on any journal entries belonging to a particular time period.

3. The multi-tenant system of claim 1, wherein generating the summarized entry comprises aggregating across particular metered attribute value fields corresponding to the journal entries, wherein the particular metered attribute value fields are associated with a given metered attribute.

4. The multi-tenant system of claim 1, wherein the computer instructions when executed by the one or more hardware processors are further configured to perform:
during the batching phase,
dividing the batch into a first subbatch and a second subbatch;
assigning a first subset of the temporally conforming journal entries to the first subbatch;
assigning a second subset of the temporally conforming journal entries to the second subbatch;
generating, within one or more staging databases, a first staging entry based on a summary of the first subset; and
generating, within the one or more staging databases, a second staging entry based on a summary of the second subset; and
and during the posting phase,
generating the summarized entry comprises summarizing the first staging entry and the second staging entry.

5. The multi-tenant system of claim 4, wherein the computer instructions when executed by the one or more hardware processors are further configured to perform:
during the batching phase, generating one or more batch status tables that are updated to track a posting status of the batch; and
generating one or more subbatch status tables that are updated to track a posting status of the first subbatch and the second subbatch.

6. The multi-tenant system of claim 4, wherein the first staging entry comprises a first staging table, the second staging entry comprises a second staging table, and the summarized entry comprises a posting table.

7. The multi-tenant system of claim 1, wherein the batching phase comprises a first batching phase, the posting phase comprises a first posting phase, the temporal criteria comprises a first temporal criteria, the journal entries comprise first journal entries, the temporally conforming journal entries comprise temporally conforming first journal entries, the batch identifier fields comprise first batch identifier fields, the assigned batch identifier comprises a first assigned batch identifier, the batch comprises a first batch, the summarized entry comprises a first summarized entry, and the computer instructions when executed by the one or more hardware processors are further configured to perform:
during a second batching phase,
obtaining, from the journal entry database, second journal entries having corresponding second temporal attributes;
populating, into respective second batch identifier fields of the second journal entries, the default batch identifier;
determining individually whether each of the second temporal attributes satisfy a second temporal criteria;
for any temporally conforming second journal entries, which have the default batch identifier and have second temporal attributes satisfying the second temporal criteria:
generating an assigned second batch identifier that assigns a second batch to the any temporally conforming second journal entries;
replacing the default batch identifier with the assigned second batch identifier; and
batching the any temporally conforming second journal entries into the second batch; and
determining, based on the temporally conforming first journal entries being assigned the first batch identifier distinct from the second batch identifier, that the temporally conforming first journal entries have already been posted; and
during a second posting phase,
generating a second summarized entry based on the any temporally conforming second journal entries within the second batch; and
inserting the second summarized entry into the posting database.

8. The multi-tenant system of claim 7, wherein the computer instructions when executed by the one or more hardware processors are further configured to perform:
during the first posting phase, validating the any temporally conforming first journal entries;
in response to any one or more temporally conforming first journal entries within the batch being invalidated, modifying the first batch identifier of the one or more invalidated journal entries to the default batch identifier; and
generating an invalidated journal entries dataset based on the one or more invalidated journal entries.

9. The multi-tenant system of claim 8, wherein the computer instructions when executed by the one or more hardware processors are further configured to perform:
during the second batching phase,
for any temporally nonconforming second journal entries, which have the default batch identifier and have second temporal attributes failing to satisfy the second temporal criteria, flagging the temporally nonconforming second journal entries; and wherein the generating of the invalidated journal entries dataset is based on the flagged journal entries.

10. The multi-tenant system of claim 1, wherein the journal entries comprise corresponding posting flags identifying a posting status; and following the posting phase, the posting flags remain unchanged.

11. A method implemented by a multi-tenant system, the method comprising:
during a batching phase,
obtaining, from a journal entry database, journal entries having corresponding temporal attributes;
populating, into respective batch identifier fields of the journal entries, a default batch identifier;
determining individually whether each of the temporal attributes satisfy a temporal criteria;
for any temporally conforming journal entries, which have the default batch identifier and have temporal attributes satisfying the temporal criteria:
generating an assigned batch identifier;
replacing the default batch identifier with the assigned batch identifier; and
assigning the any temporally conforming journal entries into the batch while excluding from the batch any temporally nonconforming journal entries, which have the default batch identifier and have temporal attributes failing to satisfy the temporal criteria; and
during a posting phase,
generating a summarized entry based on the any temporally conforming journal entries within the batch; and
inserting the summarized entry into a posting database.

12. The method of claim 11, wherein the temporal attributes comprise or identify respective time periods that the journal entries belong to, and the temporal criteria is satisfied based on any journal entries belonging to a particular time period.

13. The method of claim 11, wherein generating the summarized entry comprises aggregating across particular metered attribute value fields corresponding to the journal entries, wherein the particular metered attribute value fields are associated with a given metered attribute.

14. The method of claim 11, further comprising:
during the batching phase,
dividing the batch into a first subbatch and a second subbatch;
assigning a first subset of the temporally conforming journal entries to the first subbatch;
assigning a second subset of the temporally conforming journal entries to the second subbatch;
generating, within one or more staging databases, a first staging entry based on a summary of the first subset; and
generating, within the one or more staging databases, a second staging entry based on a summary of the second subset; and
and during the posting phase,
generating the summarized entry comprises summarizing the first staging entry and the second staging entry.

15. The method of claim 14, further comprising:
during the batching phase, generating one or more batch status tables that are updated to track a posting status of the batch; and
generating one or more subbatch status tables that are updated to track a posting status of the first subbatch and the second subbatch.

16. The method of claim 14, wherein the first staging entry comprises a first staging table, the second staging entry comprises a second staging table, and the summarized entry comprises a posting table.

17. The method of claim 11, wherein the batching phase comprises a first batching phase, the posting phase comprises a first posting phase, the temporal criteria comprises a first temporal criteria, the journal entries comprise first journal entries, the temporally conforming journal entries comprise temporally conforming first journal entries, the batch identifier fields comprise first batch identifier fields, the assigned batch identifier comprises a first assigned batch identifier, the batch comprises a first batch, the summarized entry comprises a first summarized entry, and the method further comprises:
during a second batching phase,
obtaining, from the journal entry database, second journal entries having corresponding second temporal attributes;
populating, into respective second batch identifier fields of the second journal entries, the default batch identifier;
determining individually whether each of the second temporal attributes satisfy a second temporal criteria;
for any temporally conforming second journal entries, which have the default batch identifier and have second temporal attributes satisfying the second temporal criteria:
generating an assigned second batch identifier that assigns a second batch to the any temporally conforming second journal entries;
replacing the default batch identifier with the assigned second batch identifier; and
batching the any temporally conforming second journal entries into the second batch; and
determining, based on the temporally conforming first journal entries being assigned the first batch identifier distinct from the second batch identifier, that the temporally conforming second journal entries have already been posted; and
during a second posting phase,
generating a second summarized entry based on the any temporally conforming second journal entries within the batch; and
inserting the second summarized entry into the posting database.

18. The method of claim 11, further comprising:
during the first posting phase,
validating the any temporally conforming first journal entries;
in response to any one or more temporally conforming first journal entries within the batch being invalidated, modifying batch identifier of the one or more invalidated journal entries to the default batch identifier; and
generating an invalidated journal entries dataset based on the one or more invalidated journal entries.

19. The method of claim 11, further comprising:
during the second batching phase,
for any temporally nonconforming second journal entries, which have the default batch identifier and have second temporal attributes failing to satisfy the second temporal criteria, flagging the temporally nonconforming second journal entries; and wherein the generating of the invalidated journal entries dataset is based on the flagged journal entries.

20. The method of claim 11, wherein the journal entries comprise corresponding posting flags identifying a posting status; and following the posting phase, the posting flags remain unchanged.
